(19) United States
(12) Patent Application Publication
(10) Pub. No.: US 2023/0378881 A1
(43) Pub. Date: Nov. 23, 2023

(54) CONTROL DEVICE, POWER-SUPPLY DEVICE, AND METHOD FOR CONTROLLING POWER CONVERTER

(71) Applicant: SONIC STAR GLOBAL LIMITED, Road Town (VG)

(72) Inventors: WEI-TING WANG, HSINCHU COUNTY (TW); YUEH-PING YU, HSINCHU COUNTY (TW)

(21) Appl. No.: 17/747,009

(22) Filed: May 18, 2022

(51) Int. Cl. H02M 3/335; H02M 1/08

(52) U.S. Cl. CPC H02M 3/33592; H02M 1/08

(57) ABSTRACT

The present application provides a control device, a power-supply device, and a method for controlling a power-supply device. The control device, applied to a power converter, includes a primary controller, a secondary controller and a voltage detector, wherein the power converter includes a transformer having a primary winding and a secondary winding. The primary controller is configured to generate a PWM signal having an off-time and an on-time, wherein the power converter is operative to deliver power from the primary winding to the secondary winding during the on-time. The secondary controller monitors an output voltage of the power converter and applies a preset voltage to the secondary winding according to a threshold voltage and the output voltage. The voltage detector, coupled to the primary winding, drives the primary controller to adjust a period of the PWM signal in response to the application of the preset voltage.

### TECHNICAL FIELD

The present disclosure relates to an isolated power converter design, and more particularly, to a control device, a power-supply device, and a control method for the power-supply device.

### DISCUSSION OF THE BACKGROUND

A power supply for an electronic product generally requires electrical isolation between its input and output ends. The electrical isolation can be realized, for example, by a transformer, and one popular approach is a switched-mode scheme. In the switched-mode scheme, the output power can be adjusted by controlling pulses applied to one or more switches coupled to a primary winding of the transformer. More particularly, the turn-on time of the pulses increases when the output power is to be increased, and the turn-on time of the pulses decreases when the output power is to be decreased.

This Discussion of the Background section is provided for background. information only. The statements in this Discussion of the Background are not an admission that the subject matter disclosed in this Discussion of the Background section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a control device. The control device is applied to a power converter including a transformer; the transformer has a primary winding and a secondary winding. The control device includes a primary controller, a secondary controller, and a voltage detector. The primary controller is configured to generate a pulse width modulation (PWM) signal. The PWM signal is a periodic signal, each period of the PWM signal has an off-time and an on-time, and the PWM signal has a first level during the off-time and a second level during the on-time. The power converter is operative to deliver power from the primary winding to the secondary winding during the on-time. The secondary controller is configured to monitor an output voltage of the power converter and apply a preset voltage to the secondary winding according to a threshold voltage and the output voltage. The voltage detector is coupled to the primary winding and drives the primary controller to adjust a period of the PWM signal in response to the application of the preset voltage.

One aspect of-the present disclosure provides a power-supply device. The power-supply device includes a transformer, a primary switch, a rectifier, and a control device. The transformer includes a primary winding and a secondary winding. The primary switch is coupled to the primary winding, and the rectifier is coupled to the secondary winding and produces an output voltage. The control device includes a primary controller, a secondary controller, and a voltage detector. The primary controller is coupled to the primary switch and configured to generate a PWM signal. The PWM signal is a periodic signal, and each period of the PWM signal has an off-time and an on-time. The PWM signal has a first level during the off-time and a second level during the on-time. The power-supply device is operative to deliver power from the primary winding to the secondary winding during the on-time. The secondary controller, coupled to the secondary winding and the rectifier, is configured to monitor the output voltage and apply a preset voltage to the secondary winding according to a threshold voltage and the output voltage. The voltage detector is coupled to the primary winding and drives the primary controller to adjust a period of the PWM signal in response to the preset voltage.

One aspect of the present disclosure provides a control method for a power-supply device which includes a transformer having a primary winding and a secondary winding. The control method includes the step of providing a PWM signal. The PWM signal is a periodic signal, and each period of the PWM signal has an off-time and an on-time. The power-supply device is operative to deliver power from the primary winding to the secondary winding during the on-time. The control method also includes the steps of: monitoring an output voltage of the power-supply device; applying a preset voltage to the secondary winding according to the output voltage and a threshold voltage to induce a voltage fluctuation at the primary winding; and adjusting a period of the PWM signal in response to the voltage fluctuation.

With the above-mentioned configurations of the control device, the power converter design of the present disclosure is able to provide signal and power isolation by a single pair of transformer windings. One of the advantages is a small form factor, isolated solution, which reduces the size and simplifies the circuit complexity of a power-supply design.

### BRIEF DESCRIPTION OF THE DRAWINGS

A more complete understanding of the present disclosure may be derived by referring to the detailed description and claims. The disclosure should also be understood to be coupled to the Figures' reference numbers, which refer to similar elements throughout the description.

FIG. 1 is a circuit block diagram of a flyback converter with a secondary side regulation (SSR) scheme in accordance with some embodiments of the present disclosure.

FIG. 2 is a circuit block diagram of a flyback converter with a primary side regulation (PSR) scheme in accordance with some embodiments, of the present disclosure.

FIG. 3 is a circuit block diagram of a power-supply device in accordance with some embodiments of the present disclosure.

FIG. 4 is a waveform diagram illustrating signals of the power-supply device in accordance with some embodiments of the present disclosure.

FIG. 5 is a circuit block diagram of a power-supply device in accordance with some embodiments of the present disclosure.

### DETAILED DESCRIPTION

Embodiments, or examples, of the disclosure illustrated in the drawings are described below using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates, Reference numerals may be repeated throughout the embodiments, but this does not necessarily mean that feature(s) of one embodiment apply to another embodiment, even if they share the same reference numeral.

It will be understood that when an element is referred to as being “connected to” or “coupled to” another element, it may be directly connected to or coupled to the other element, or intervening elements may be present. Moreover, as described herein, the terms “assert”, “asserted”, “assertion”, “de-assert”, “de-asserted” and “de-assertion” will be used to avoid confusion when dealing with a mixture of “active high” and “active low” signals. “Assert”, “asserted” and “assertion” are used to indicate that a signal is rendered active, or logically true. “De-assert”, “de-asserted” and “de-assertion” are used to indicate that a signal is rendered inactive, or logically false.

The terminology used herein is for the purpose of describing particular example embodiments only and is not intended to be limiting to the present inventive concept. As used herein, the singular forms “a,” “an” and “the” are intended to include the plural forms as well, unless the context clearly indicates otherwise. It shall be understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

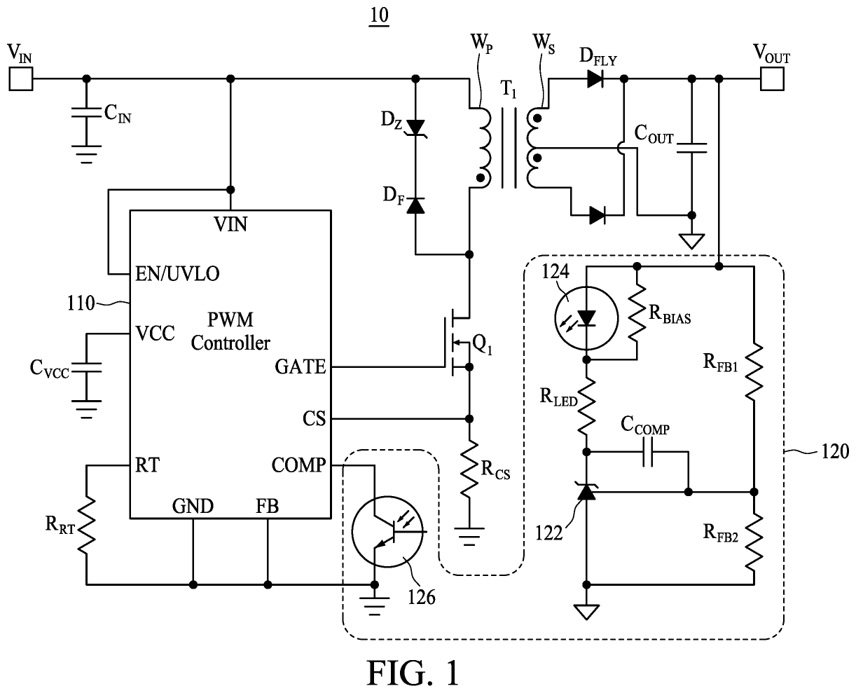

FIG. 1 is a circuit block diagram of a flyback converter 10 with a secondary side regulation (SSR) scheme in accordance with some embodiments of the present disclosure. Referring to FIG. 1, the flyback converter 10 receives an input voltage V_{IN} and provides an output voltage V_{OUT} to drive a load (not shown). The input voltage V_{IN} be a rectified direct current (DC) voltage provided by, for example, a full or half-bridge rectifier.

The flyback converter 10 includes an input capacitor C_{IN}, a pulse width modulation (PWM) controller 110, a switch Q₁, a transformer T₁, a flyback diode D_{FLY}, an output capacitor C_{OUT}, and a feedback unit 120. The input capacitor C_{IN} serves as a filter to smooth the input voltage V_{IN}. When the PWM controller 110 starts to operate, it outputs a PWM signal to drive the switch Q₁. When the switch Q₁ is on, the input power V_{IN} is coupled to ground through a primary winding W_{P} of the transformer T₁, the switch Q₁, and a resistor R_{CS}. The resistor R_{CS} provides a current sense signal to a current sense (CS) terminal of the PWM controller 110. The flyback diode D_{FLY} is coupled between a secondary winding W_{S} of the transformer T₁ and the output capacitor C_{OUT} while the output capacitor C_{OUT} is coupled between the flyback diode D_{FLY} and the ground.

The feedback unit 120 includes a shunt regulator (for example, TL431) 122 and an optocoupler to generate a feedback signal based on the output voltage V_{OUT}. The optocoupler; including a light emitter 124 and a light receiver 126, offers a convenient way to capture output-voltage error information of the flyback converter 10. The shunt regulator 122 has a reference terminal, which is electrically connected to a first feedback resistor R_{FB1} and a second feedback resistor R_{FB2} in series connection. The light emitter 124 is coupled to a cathode of the shunt regulator 122 through a resistor R_{LED}, and the light receiver 126 is connected to the PWM controller 110. The feedback unit 120 can further include a resistor R_{BIAS} electrically coupled to the light emitter 124 in parallel and a capacitor C_{COMP} connected between the cathode and the reference terminal of the shunt regulator 122.

The flyback converter 10 may further include diodes D_{Z} and D_{F}. The D_{Z} is, for example, a zener diode and is connected to the diode D_{F} in series. The diodes D_{Z} and D_{F} are coupled across the primary winding W_{P} of the transformer T₁ and function as a transient voltage suppressor for protection against voltage spikes.

in operation, the primary winding W_{P} of the transformer T₁ is energized when the PWM controller 110 drives the switch Q₁ on. While the switch Q₁ is off, energy is transferred from the primary winding W_{P} to the secondary winding W_{S} of the transformer T₁, inducing a time-varying current that flows in the secondary winding W_{S}. The induced current generates an alternating current (AC) voltage, which in turn can be rectified and filtered by the flyback diode D_{FLY} and the output capacitor C_{OUT}, to produce the DC output voltage V_{OUT}. The shunt regulator 122 regulates the amount of light emitted by the light emitter 124 based on a voltage across the second feedback resistor R_{FB2}. The PWM controller 110 controls the switch Q₁ based on the feedback signal including a current flowing in the light receiver 126 so as to stabilize the output voltage V_{OUT}. There is a correlation between the current flowing in the light receiver 126 and the amount of light emitted by the light emitter 124, and the current flowing in the light receiver 126 is dependent on the current transfer ratio of the optocoupler.

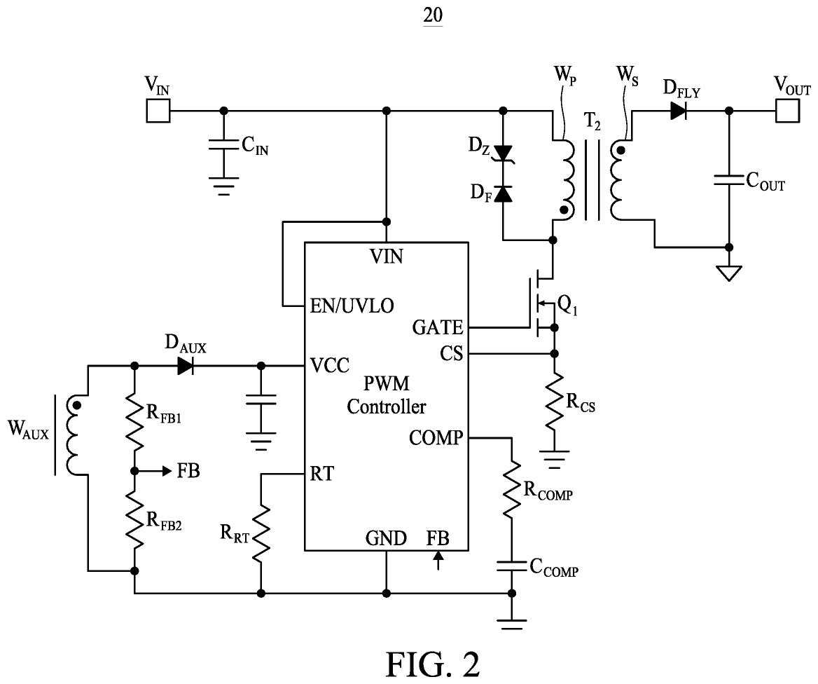

FIG. 2 is a circuit block diagram of a flyback converter 20 with a PSR scheme in accordance with some embodiments of the present disclosure. Referring to FIG. 2, the flyback converter 20 includes an input capacitor C_{IN}, a transformer T₂, a switch Q₁, a PWM controller 210, a flyback diode D_{FLY}, a diode D_{AUX}, a first feedback resistor R_{FB1}, and a second feedback resistor R_{FB2}. The transformer T₂ includes a primary winding W_{P}, a secondary winding W_{S}, and an auxiliary winding W_{AUX}. The primary winding W_{P} is coupled to an input voltage V_{IN}, the input capacitor C_{IN} and the switch Q₁. The secondary winding W_{S}, magnetically coupled to the primary winding W_{P}, is coupled to the flyback diode D_{FLY}; the auxiliary winding W_{AUX}, magnetically coupled to the primary winding W_{P}, is coupled to the diode D_{AUX}. The first and second feedback resistors R_{FB1} and R_{FB2}connected in series are coupled across the auxiliary winding W_{AUX}.

When the switch Q₁ is turned on, an input voltage V_{IN} is smoothed by the input capacitor C_{IN} and conducted to the primary winding W_{P} of the transformer T₂ to energize the primary winding W_{P}. When the switch Q₁ is off, energy on the primary winding W_{P} is transferred to the secondary winding W_{S} and the auxiliary winding W_{AUX} of the transformer T₂, inducing time-varying currents that flow in the secondary winding W_{S} and in the auxiliary winding W_{AUX}. The induced current flowing in the auxiliary winding W_{AUX} generates an AC voltage. The AC voltage generated in the auxiliary winding W_{AUX} of the transformer T₂ is rectified by the flyback diode D_{FLY}, to produce a DC voltage V_{CC} to the PWM controller 210. Meanwhile, a voltage across the second feedback resistor R_{FB2} is input to a feedback (FB) terminal of the PWM controller 210. The PWM controller 210 controls the switch Q₁ based on the voltage input to the feedback terminal, so as to stabilize an output voltage V_{OUT} generated using the secondary winding W_{S}, the flyback diode D_{FLY} and an output capacitor C_{OUT}. The auxiliary winding W_{AUX} of the power converter 20 simplifies a circuit complexity since the PSR scheme eliminates the shunt regulator, the optocoupler, and associated resistors and capacitors for the feedback divider and compensation.

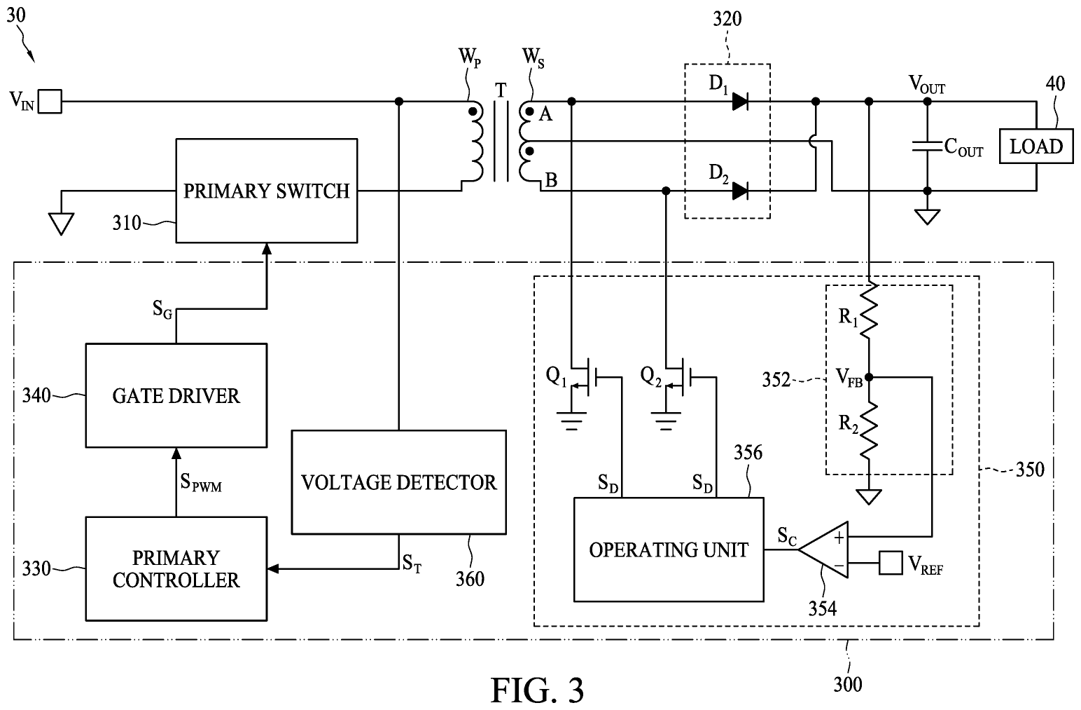

FIG. 3 is a circuit block diagram of a power-supply device 30 in accordance with some embodiments of the present disclosure. Referring to FIG. 3, the power-supply device 30 receives an input voltage V_{IN} and provides an output voltage V_{OUT} to drive a load 40. The input voltage V_{IN} may be a rectified direct current (DC) voltage provided by, for example, a full or half-bridge rectifier.

The power-supply device 30 includes a transformer T, a control device 300, a primary switch 310, and a rectifier 320. The transformer T, the primary switch 310, and the rectifier 320 form a flyback converter to produce the output voltage V_{OUT}. In detail, the transformer T includes a primary winding W_{P} and a secondary winding W_{S} magnetically coupled to the primary winding W_{P}; the primary winding W_{P} is coupled to the control device 300 and the primary switch 310, and the secondary winding W_{S} is coupled to the control device 300 and the rectifier 320. The primary switch 310 can be implemented as an n-channel metal oxide semiconductor field-effect transistor (MOSFET); however, other types of primary switch 310 may be used. The rectifier 320 includes a pair of diodes D₁ and D₂ connected to a first end A and a second end B of the secondary winding W_{S}, respectively. Alternatively, the rectifier 320 may be simply a diode or be implemented as a synchronous rectifier. The power-supply device 30 may further include an output capacitor C_{OUT} coupled to the rectifier 320 for filtering voltage ripples.

The control device 300 is electrically connected to the flyback converter to regulate the output voltage V_{OUT}. The control device 300 includes a primary controller 330, a gate driver 340, a secondary controller 350, and a voltage detector 360. The primary controller 330, managing output regulation, is coupled to the voltage detector 360. The primary controller 330 is, for example, a pulse width modulation (PWM) controller and configured to generate a PWM signal S_{PWM} in response to a power supply requirement.

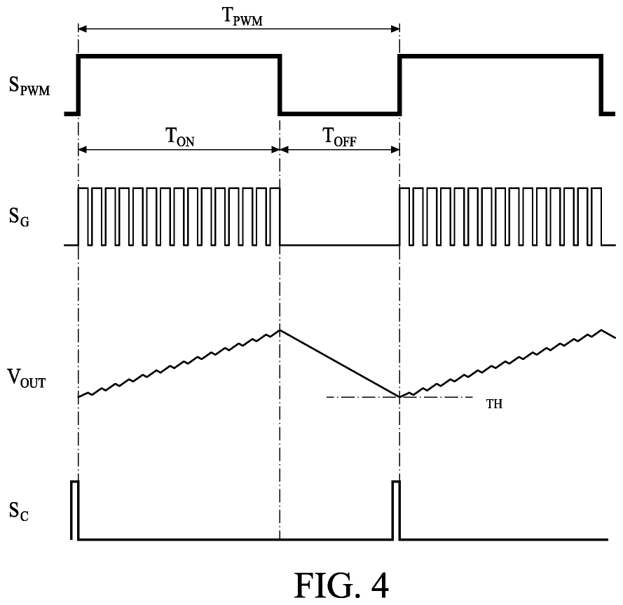

Referring to FIG. 4, the PWM signal S_{PWM} is a periodic signal. Each period T_{PWM} of the PWM signal S_{PWM} has an off-time T_{OFF} and an on-time T_{ON}. The PWM signal S_{PWM} can have a high level during the on-time T_{ON} and a low level during the off-time T_{OFF}. In general, a maximum value of the output voltage V_{OUT}is determined by the on-time T_{ON} of the PWM signal S_{PWM}. The transformer T, the secondary controller 350, and the voltage detector 360 collectively provide output voltage information to the primary controller 330, so that the primary controller 330 may adjust the period T_{PWM} of the PWM signal S_{PWM} to maintain output regulation, as will be described below.

Referring to FIGS. 3 and 4, the gate driver 340 is coupled to the primary switch 310 and the PWM controller 330. The gate driver 340 is responsive to the PWM signal S_{PWM} and operable to generate a gate signal S_{G} in order to drive the primary switch 310 in on and off states alternately during the on-time T_{ON} of the PWM signal S_{PWM}, thereby controlling the output voltage V_{OUT}. As can be seen in FIG. 4, the gate signal S_{G} is at the low level during the off-time T_{OFF} of the PWM signal S_{PWM}. That is, during the off-time T_{OFF} the PWM signal S_{PWM}, the primary switch 310 remains in the off state, and no current flows through the primary winding W_{P}. During the on-time T_{ON} of the PWM signal S_{PWM}, the gate signal S_{G} alternates between low and high levels with a frequency higher than that of the PWM signal S_{PWM}. In some embodiments, the PWM signal frequency ranges from 600 kHz to 650 kHz, and the gate signal S_{G} alternates at a frequency about 30 MHz.

Referring again to FIG. 3. the secondary controller 350 is arranged to monitor the output voltage V_{OUT} and to apply a preset voltage to the secondary winding W_{S} when the output voltage V_{OUT} is not greater than a threshold voltage V_{TH}, as shown in FIG. 4. The preset voltage is applied to the secondary winding W_{S} during the off-time T_{OFF} of the PWM signal S_{PWM}. The preset voltage can induce a voltage fluctuation at the primary winding W_{P} when the preset voltage is applied to the secondary winding W_{S}. In some embodiments, the preset voltage is a common ground voltage.

The secondary controller 350 can include a voltage sampling unit 352, a comparator 354, an operating unit 356, and a pair of secondary switches Q₁ and Q₂. The voltage sampling unit 352 and the comparator 354 are configured to monitor the output voltage V_{OUT}, and the operating unit 356 and the pair of secondary switches Q₁ and Q₂ collectively apply the preset voltage to the secondary winding W_{S} based on a monitoring result.

The voltage sampling. unit 352 is coupled to the rectifier 320 and generates information indicative of the output voltage V_{OUT}. More particularly, the voltage sampling unit 352 produces a feedback voltage V_{FB} based on the output voltage V_{OUT}. The feedback voltage V_{FB} is a voltage-divided version of the output voltage V_{OUT}, such that the feedback voltage V_{FB} has a magnitude proportional to that of the output voltage V_{OUT}. As can be seen in FIG. 3, a voltage divider is made up of two resistors R₁ and R₂ connected in series, and the feedback voltage V_{FB} is the voltage across the resistor R₂.

The feedback voltage V_{FB} is provided to a non-inverting input of the comparator 354. The comparator 354 also receives a reference voltage V_{REF} that is related to the threshold voltage V_{TH} at an inverting input. The comparator 354 may compare the feedback voltage V_{FB} with the reference voltage V_{REF} and generate a comparison signal S_{C} indicating whether to activate the operating unit 356. Note that the ratio of the threshold voltage V_{TH} to the reference voltage V_{REF} is preferably greater than the ratio of the output voltage V_{OUT} to the feedback voltage V_{FB}.

The operating unit 356 is coupled between the secondary switches Q₁ and Q₂ and the comparator 354. The operating unit 356 receives the comparison signal S_{C} and is configured to generate a driving signal S_{D} to control the pair of secondary switches Q₁ and Q₂. The secondary switch Q₁ is connected to the first end A of the secondary winding W_{S}, while the secondary switch Q₂ is connected to the second end B of the secondary winding W_{S}. The secondary switches Q₁ and Q₂ can be implemented as n-channel MOSFETs; however, other types of secondary switches Q₁ and Q₂ may be used.

Referring to FIGS. 3 and 4, during the on-time T_{ON} of the PWM signal S_{PWM}, the gate driver 340 controls the primary switch 310 to switch between on and off states at a frequency about 30 MHz for example. When the primary switch 310 is in the on state, the input voltage V_{IN} is conducted to the primary winding W_{P} of the transformer T to energize the primary winding W_{P}; when the primary switch 310 is in the off state, energy on the primary winding W_{P} is transferred to the secondary winding W_{S} to generate the output voltage V_{OUT}. The resulting output voltage V_{OUT} is illustrated in FIG. 4. As can be seen, the output voltage V_{OUT} continuously increases and is always greater than the threshold voltage V_{TH} during the on-time T_{ON}. As such, the operating unit 356 of the secondary controller 350 is inactivated during the on-time T_{ON} to reduce power consumption.

During the off-time T_{OFF} of the PWM signal S_{PWM}, the primary switch 310 remains in the off state so as to prevent a current flowing through the primary winding W_{P}. Accordingly, the output voltage V_{OUT} steadily decreases. The secondary controller 350 is operable to monitor the output voltage V_{OUT} and to induce the voltage fluctuation at the primary winding W_{P} once the output voltage V_{OUT} reaches the threshold voltage V_{TH}.

Specifically, the operating unit 356 can be activated to assert the driving signal S_{D} to turn off both of the switches Q₁ and Q₂, when the operating unit 356 receives the comparison signal S_{C} indicating that the output voltage V_{OUT} is greater than the threshold voltage V_{TH}, Once the comparator 354 issues the comparison signal S_{C} indicating that the output voltage V_{OUT} reaches the threshold voltage V_{TH}, the operating unit 356 de-assert the driving signal S_{D}, which is logic high and thus turns on both of the secondary switches Q₁ and Q₂. Consequently, the secondary winding W_{S} is grounded.

Grounding the secondary winding W_{S} as the primary switch 310 remains off causes a voltage fluctuation at the primary switch 310. The voltage detector 360 can detect the voltage at the primary winding W_{P}. Once sensing the voltage fluctuation, the voltage detector 360 provides a trigger signal S_{T} to the primary controller 330. As a result, the primary controller 330 is triggered to bring the PWM signal S_{PWM} to a high level. That is, a current period T_{PWM} of the PWM signal S_{PWM} is forced to terminate, thus maintaining output regulation. In some embodiments, the primary controller 330 may bring the PWM signal S_{PWM} to the high level by restarting the PWM signal S_{PWM} with the on-time T_{ON} of a period T_{PWM}.

In order to reduce the power consumption, the voltage detector 360 does not operate during the on-time T_{ON} of the PWM signal S_{PWM}.

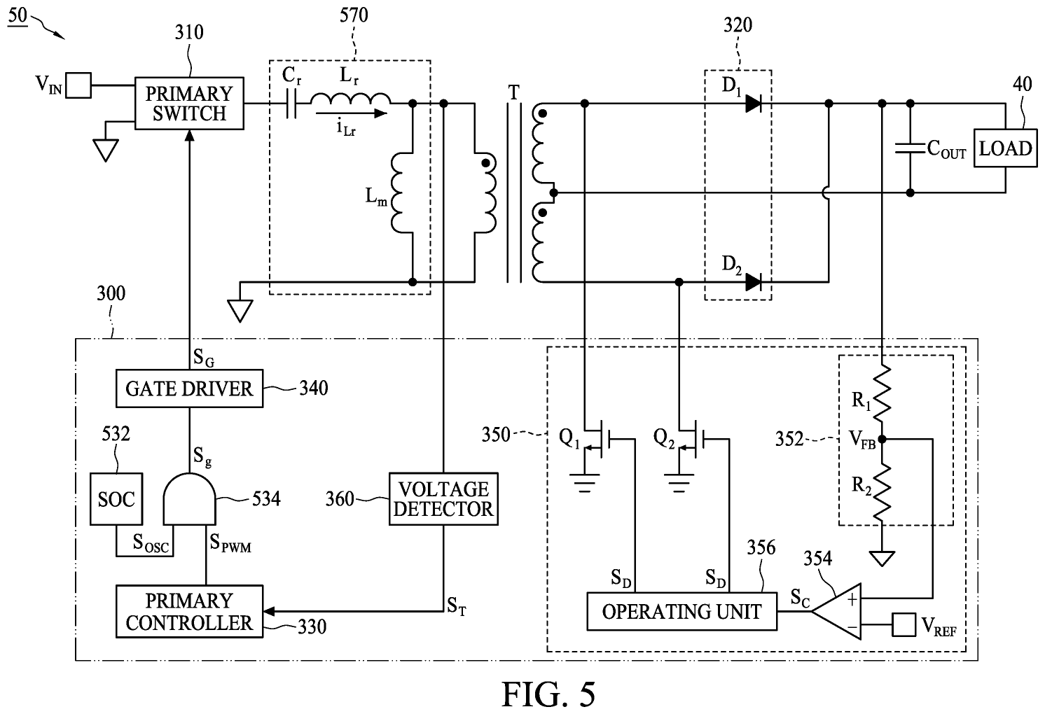

The power converter design of the present disclosure is also applicable to a resonant converter that uses two inductors (LL) and a capacitor (C), known as LLC configuration. FIG. 5 is a block diagram of a power-supply device 50 with the LLC configuration in accordance with some embodiments of the present disclosure. In FIG. 5, similar numerals of reference are employed to denote the corresponding components of FIG. 3. As the embodiment illustrated by FIG. 3. the power-supply device 50 also includes a transformer T, a control device 300, a primary switch 310, and a rectifier 320, Additionally, the power-supply device 50 includes an LLC circuit 570 that is made up of one capacitor Cᵣ and two inductors Lᵣ and Lₘ. Note that the control device 300 further includes an oscillator OSC 532 and an AND gate 534. The oscillator 532 generates a square-wave signal S_{OSC} having a frequency ranging from 30 MHz-200 MHz for example. As described earlier, the primary controller 330 generates a PWM signal S_{PWM} having a frequency of about 650 KHz for example, The AND gate 534 receives the square-wave signal S_{OSC} and the PWM signal S_{PWM} as inputs, multiplying its two input signals S_{OSC} and S_{PWM} via a logical AND operation to produce an output signal S_{g}. According to some embodiments of the present disclosure, the oscillator 532 and the AND gate 534 are both incorporated into the gate driver 340. According to some other embodiments of the present disclosure, the primary controller 330 is integrated with the oscillator 532 and the AND gate 534. The output signal S_{g} of the AND gate 534 is fed to the gate driver 340 which generates a gate signal S_{G} to drive the primary switch 310 alternating between on and off states during the on-time T_{ON} of the PWM signal S_{PWM}.

When the output voltage V_{OUT} is equal to or less than a threshold voltage Vₜₕ, the control device 300 pulls down the voltage across the secondary winding W_{S} of the transformer T. This induces a voltage fluctuation at the primary winding W_{P} of the transformer T. In response, the primary controller 330 terminates a current period of the PWM signal S_{PWM} by setting the signal S_{PWM} to a high level, and thus output regulation can be maintained. In the two embodiments illustrated by FIGS. 3 and 5, components with similar functions or the same functions are represented by similar symbols, so the details will not be further described here for brevity.

In conclusion, the power converter design of the present disclosure offers signal and power isolation by a single pair of transformer windings. One of the advantages is a small form factor, isolated solution, which can reduce the size and simplify the circuit complexity of a power-supply device.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to he limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. A control device, applied to a power converter comprising a transformer, wherein the transformer has a primary winding and a secondary winding, and the control device comprises:
a primary controller configured to generate a pulse width modulation (PWM) signal, wherein the PWM signal is a periodic signal, and each period of the PWM signal has an off-time and an on-time, and the PWM signal has a first level during the off-time and a second level during the on-time, wherein the power converter is operative to deliver power from the primary winding to the secondary winding during the on-time;
a secondary controller configured to monitor an output voltage of the power converter and apply a preset voltage to the secondary winding according to a threshold voltage and the output voltage; and
a voltage detector, coupled to the primary winding, driving the primary controller to adjust a period of the PWM signal in response to the application of the preset voltage.

2. The control device of claim 1, wherein the primary controller is triggered to terminate the period of the PWM signal once the preset voltage is applied to the secondary winding during the off-time of the PWM

3. The control device of claim 2, wherein the preset voltage applied to the secondary winding induces a voltage fluctuation at the primary winding, and the voltage detector provides a trigger signal to the primary controller once sensing the voltage fluctuation such that the primary controller is triggered to terminate the period of the PWM

4. The control device of claim 3, wherein the PWM signal is brought to the second level from the first level once the primary controller receives the trigger signal.

5. The control device of claim I, further comprising a gate driver receiving the PWM signal and generating a gate signal to control a primary switch of the power converter in on and off states alternately during the on-time of the PWM signal, wherein the primary switch of the power converter is coupled to the primary winding.

6. The control device of claim 5, wherein the gate signal has a frequency higher than that of the PWM signal.

7. The control device of claim 1, wherein the secondary controller comprises:
a pair of secondary switches coupled to the secondary winding;
a voltage sampling unit producing a feedback voltage based on the output voltage;
a comparator, coupled to the voltage sampling unit, comparing the feedback to voltage to a reference voltage, wherein the reference voltage is related to the threshold voltage; and
an operating unit, coupled between the secondary switch pair and the comparator, configured to generate a driving signal to control the secondary switches according to a comparison between the feedback voltage and the reference voltage.

8. The control device of claim 7, wherein the operating unit asserts the driving signal for turning on the pair of secondary switches to ground the secondary winding when the feedback voltage is less than or equal to the reference voltage.

9. The control device of claim 7, wherein the voltage sampling unit comprises a first resistor and a second resistor connected in series, and the feedback voltage is a voltage across the second resistor.

10. A power-supply device, comprising:
a transformer comprising a primary winding and a secondary winding;
a primary switch coupled to the primary winding;
a rectifier, coupled to the secondary winding, producing an output voltage; and
a control device, comprising:
a primary controller coupled to the primary switch and configured to generate a pulse width modulation (PWM) signal, wherein the PWM signal is a periodic signal, and each period of the PWM signal has an off-time and an on-time, and the PWM signal has a first level during the off-time and a second level during the on-time, wherein the power-supply device is operative to deliver power from the primary winding to the secondary winding during the on-time;
a secondary controller, coupled to the secondary winding and the rectifier, configured to monitor the output voltage and apply a preset voltage to the secondary winding according to a threshold voltage and the output voltage; and
a voltage detector, coupled to the primary winding, driving the primary controller to adjust a period of the PWM signal in response to the preset voltage.

11. The power-supply device of claim 10, wherein the primary controller is triggered to terminate the period of the PWM signal once the preset voltage is applied to the secondary winding during the off-time of the PWM

12. The power-supply device of claim 10, wherein the preset voltage applied to the secondary winding induces a voltage fluctuation at the primary winding, and the voltage detector provides a trigger signal to the primary controller once sensing the voltage fluctuation such that the primary controller is triggered to terminate the period of the PWM

13. The power-supply device of claim 12, wherein the PWM signal is brought to the second level from the first level once the primary controller receives the trigger signal.

14. The power-supply device of claim 10, wherein the control device further comprises a gate driver receiving the PWM signal and generating a gate signal to control the primary switch in on and off states alternately during the on-time of the PWM

15. The power-supply device of claim 10, wherein the secondary controller comprises:
a pair of secondary switches coupled to the secondary winding;
a voltage sampling unit, coupled to the rectifier, producing a feedback voltage based on the output voltage;
a comparator, coupled to the voltage sampling unit, comparing the feedback voltage to a reference voltage, wherein the reference voltage is related to the threshold voltage; and
an operating unit, coupled between the secondary switch pair and the comparator, configured to generate a driving signal to control the secondary switches according to a comparison between the feedback voltage and the reference voltage.

16. The power-supply device of claim 15, wherein the operating unit asserts the driving signal for turning on the pair of secondary switches to ground the secondary winding when the feedback voltage is less than or equal to the reference voltage.

17. A control method for a power-supply device which comprises a transformer having a primary winding and a secondary winding, the control method comprising:
providing a PWM signal, wherein the PWM signal is a periodic signal, and each period of the PWM signal has an off-time and an on-time, wherein the power-supply device is operative to deliver power from the primary winding to the secondary winding during the on-time;
monitoring an output voltage of the power-supply device;
applying a preset voltage to the secondary winding according to the output voltage and a threshold voltage to induce a voltage fluctuation at the primary winding; and
adjusting a period of the PWM signal in response to the voltage fluctuation.

18. The control method of claim 17, wherein the step of adjusting comprises terminating the period of the PWM signal once the preset voltage is applied to the secondary winding during the off-time of the PWM signal.

19. The control method of claim 17, further comprising:
producing a feedback voltage based on the output voltage;
comparing the feedback voltage with a reference voltage that is related to the threshold voltage; and
applying the preset voltage to the secondary winding when the feedback voltage is less than or equal to the reference voltage.

20. The control method of claim 17, wherein the step of applying the preset voltage comprises connecting the secondary winding toward ground.
